(19) United States
(12) Patent Application Publication
(10) Pub. No.: US 2014/0106108 A1
(43) Pub. Date: Apr. 17, 2014

(54) BUILDING BLOCKS

(71) Applicants: Chi Kin Lin, Hongkong (CN); Tsz Chung Lin, Hongkong (CN)

(72) Inventors: Chi Kin Lin, Hongkong (CN); Tsz Chung Lin, Hongkong (CN)

(73) Assignee: Tsz Chung Lin, Kwai Chung, N.T. Hong Kong (CN)

(21) Appl. No.: 13/700,837

(22) PCT Filed: Jun. 8, 2012
(86) PCT No.: PCT/IB12/52897

§ 371 Date: Nov. 29, 2012

(30) Foreign Application Priority Data
Jun. 10, 2011 (HK) 11105900.5

(51) Int. Cl. B32B 3/06; A63H 33/04; F16S 1/02; E04B 1/02

(52) U.S. Cl. CPC B32B 3/06; E04B 1/02; A63H 33/04; F16S 1/02
USPC 428/58; 428/99

(57) ABSTRACT

A building block comprising a panel member having a forward panel surface and a rearward panel surface, and a peripheral skirt extending rearward from the rearward panel surface and defining a receptacle; wherein an interconnection means adapted for making sidewise locked interconnection with an adjacent building block having a complementary or counterpart interconnection means is formed on the peripheral shirt, the interconnection means being a female connection member or a male connection member complementary to the female member; wherein the female member is shaped or adapted to permit a male connection member of the adjacent building block to enter into sidewise locked interconnection by entering at the free end of the peripheral skirt which is distal from the panel member, to move towards the forward panel surface, and to stop before reaching the forward panel surface.

### FIELD

The present disclosure relates to building blocks, and more particularly to building blocks adapted for forming into a building structure including an assembly of sidewise interconnected building blocks. The present disclosure also relates to a panel assembly formed from a plurality of building blocks in sidewise interconnection relationship and a building structure comprising such an assembly.

### BACKGROUND

Many structures are constructed from modular building blocks though locked interconnection of the modular building blocks. Examples of such structures include, for example, buildings, vehicles, machinery, toys, models, furniture and stationery. The modular building blocks usually comprise integrally formed interconnection means for making mated interconnection with adjacent building blocks in order to enhance structural robustness. The interconnection means typically comprises complementary mating members on counterpart building blocks to facilitate the mated interconnection.

Modular building blocks comprising complementary mating members on opposite end and side surfaces are usually stacked and then interlocked both vertically and horizontally to attain a desirable height from a base of a desirable form. To facilitate constructions of 3-dimensional structures, building blocks are required to have connection means on their sides as well as their ends.

U.S. Pat. No. 6,050,044 discloses building blocks having connectors on its opposite and side walls. The connectors on the side walls comprising interlocking male and female dovetails for connecting blocks side by side in addition to connectors on its upper and lower ends for connecting the blocks vertically. The building blocks also have mating ribs and grooves on the side walls to minimize twisting movement between horizontally attached blocks.

It is noted that building blocks having conventional interconnection means are not entire satisfactory for many applications.

### SUMMARY OF THE INVENTION

Accordingly, there is provided a building block comprising a panel member having a forward (or upper) panel surface and a rearward (or lower) panel surface, and a peripheral skirt extending rearward from the rearward panel surface and defining a receptacle; wherein an interconnection means adapted for making sidewise locked interconnection with an adjacent building block having a complementary or counterpart interconnection means is formed on the peripheral shirt, the interconnection means being a female connection member or a male connection member complementary to the female member; wherein the female member is shaped or adapted to permit a male connection member of the adjacent building block to enter into sidewise locked interconnection by entering at the free end of the peripheral skirt which is distal from the panel member, to move towards the forward panel surface, and to stop before reaching the forward panel surface.

A building block comprising a female connection member which is adapted to cooperate with a male connection member of a counterpart building block to facilitate sidewise locked interconnection while preventing the male connection member to reach the forward panel surface is advantageous. For example, such an arrangement protects the interconnection means from direct external access to mitigate damage due to vandalism or weathering, as the forward panel surface is usually adapted for outward or external facing. In addition, as the free end of the peripheral skirt is located on the rearward side, an adjacent building block can be mounted and removed from the rearward side. Moreover, as advancement of the connection member will be stopped by the panel member, and the resistance will be distributed on the panel member, thereby reducing local tension on a small portion on the peripheral skirt for enhanced reliability. Furthermore, as the interconnection means to facilitate sidewise interconnection of building blocks are behind the panel member, the risk of a building block coming out from the forward side, for example, due to damage of some of the interconnection means, are mitigated.

In an example, the entirety of the interconnection means is located rearward of the forward panel surface, such that the interconnection means is blocked from forward access by the forward panel surface when the interconnection means is engaged in sidewise locked interconnection with the adjacent building block.

For example, the panel member may form a stop portion of the female connection member which is adapted to stop movement of the male connection member of the adjacent building block to reach the forward panel surface on entering into the sidewise locked interconnection. Use of the panel member as a stop portion means there is no need to form a separate stop portion to restrict axial movement of the male member when in locked interconnection.

The boundary of the panel member defining the forward panel surface may include no sidewise indentation and no sidewise protrusion. This is beneficial as the boundary can be made to a preferred outline without being limited by the shape of the interconnection means. For example, the boundary of the panel member defining the forward panel surface may defines a circle, an oval or a convex polygon, and such a possibility is not available

For example, the female connection member may be adapted such that when the male connection member on the adjacent building block is blocked or stopped by the female connection member on advancing towards the forward panel surface, the forward panel surface of the adjacent building block is flush with the forward panel surface. This facilitates automatic alignment of the forward surfaces for expeditious assembly of building blocks.

An elongate aperture may be formed on the peripheral surface to define the female connection member, the elongate aperture being a cut-through on the peripheral skirt which extends from the free end of the peripheral skirt towards the panel member. A female connection member defined by a cut-through portion on the peripheral skirt is advantageous because it would be simpler to form and different forms of male connection member can operate with such a female connection member.

The female connection may have a wedge shaped profile in the sidewise direction to formed sidewise wedged engagement with the male connection member.

In an example, the male connection member projects orthogonally away from the peripheral skirt and comprises an elongate member which extends in a direction orthogonally to the forward panel surface, the elongate member terminates before reaching the forward panel surface.

For example, the male connection member may comprise a T-shaped portion projecting from the peripheral skirt, the end of the T-shaped portion most distal from the peripheral skirt is adapted to protrude into the receptacle of that adjacent building block to formed the side wise locked interconnection. The T-shaped member may comprise an elongate neck portion which connects the distal end of the T-shaped member to the peripheral skirt. The neck portion will pass through the peripheral skirt when making sidewise interconnection with an adjacent building block.

To enhance secured interconnection between adjacent building blocks, the interconnection means may be adapted for making mated interconnection with a counterpart complementary interconnection means in that adjacent building block.

Each interconnection means may comprise a mating member which extends in a longitudinal direction that is orthogonally to the forward panel surface and has its longitudinal ends retracted from the forward panel surface. In other words, the mating member is located below the forward panel surface and retracted therefrom. This provides distributed locked interconnection in the axial direction while concealing the interconnection means from the forward side of building block when in interconnection.

The mating member may comprise a wedging member for making locked interconnection with a counterpart complementary mating member on that adjacent building block. The wedging member is shaped to act to tighten the locked interconnection on reacting to a movement in a direction to separate the building block from that adjacent building block in a direction orthogonal to the peripheral surface or in a direction parallel to the forward panel surface.

For example, the interconnection means may comprise a male mating member, the male mating member projecting orthogonally away from the peripheral surface and extending as an elongate member in a direction orthogonally to the forward panel surface, and the male member stops before reaching the forward panel surface.

The male mating member may comprises a T-shaped member having a transversely extending end portion adapted to protrude into the receptacle of that adjacent building block to formed the locked interconnection.

The interconnection means may comprise a female connection member which defines an elongate indentation on the peripheral surface which is wedge shaped and which extends orthogonal to the forward panel surface. The indentation may stop before reaching the forward panel surface to providing blocking to prevent forward movement of a counterpart male mating member to move beyond the panel member.

The receptacle may be adapted for making mated engagement with a protruding portion of a counterpart building block.

As an example, the forward panel surface may be a top panel surface of a panel member, the panel member having a top panel surface and a bottom panel surface, and the peripheral surface defines a peripheral skirt which is downwardly dependent from the panel member and surrounds the bottom panel surface.

The interconnection means may be located at a level below the top panel surface and is adapted to be hidden by that adjacent building block when in locked interconnection therewith. Such an arrangement facilitates the construction of panels from interconnecting building block modules while mitigating unsightly joints of interconnection means as well as risks of removal of a building block through outside access.

The plurality of interconnection means may comprise at least one male mating member and at least one female connection member complementary to the male mating member.

The interconnection means may be located on a centerline on one side of the peripheral surface, the centerline being orthogonal to the forward panel surface.

The panel member may have a polygonal shaped top panel surface and peripheral surface, and the interconnection means may be located on each side of the polygonal peripheral surface.

Where the panel member has a circular or oval forward panel surface, the plurality of interconnection means may be distributed on the perimeter.

The forward panel surface may be a flat, leveled or textured surface.

The building block may be integrally formed of plastics.

A plurality of mating protrusions for making mated engagement with a counterpart building block may be distributed on the forward panel surface, the protrusions extending orthogonally to the forward panel surface.

In an example, there is described a panel assembly comprising a plurality of the building blocks described herein in locked interconnection.

The panel assembly may comprise a leveled or flat panel surface formed collectively from a plurality of the forward panel surfaces of the building blocks.

The above and other features of the building blocks will be described in more detail below.

### BRIEF DESCRIPTION OF DRAWINGS

Embodiments of building blocks and panels built therefrom will be explained below by way of example and with reference to the accompanying drawings or figures, in which:

FIG. 1 is a top perspective view of a first example of building block,

FIGS. 1A, 1B, 1C, 1D and 1E are respectively bottom perspective, top plan, bottom plan, first side and second side views of the building block of FIG. 1,

FIGS. 2 and 2A are respectively top and bottom perspective views of a second example building block,

FIGS. 3 and 3A are respectively top and bottom perspective views of a third example building block,

FIGS. 4 and 4A are respectively top and bottom perspective views of a fourth example building block,

FIGS. 5 and 5A are respectively top and bottom perspective views of a fifth example building block,

FIGS. 6 and 6A are respectively top and bottom perspective views of a sixth example building block,

FIGS. 7, 7A and 7B are respectively top and bottom perspective views and bottom plan view of an example panel assembled from the first to the sixth example building blocks,

FIGS. 8, 8A to 8E are respectively top perspective, bottom perspective, bottom plan, first side and second side views of a seventh example building block,

FIGS. 9 and 9A are respectively top and bottom perspective views of an example of another panel,

FIG. 10 is top perspective view of an example of another panel,

FIGS. 11A to 11D are respectively a top plan view, a bottom plan view, a first side view in the direction from A′ to A, and a second side view in the direction from A to A′ of an eighth example building block,

FIG. 12 is a rear perspective view of a building structure comprising a panel assembly constructed from a plurality of eighth example building blocks and its variant mounted on a frame structure,

FIG. 12A is a front perspective view of FIG. 12 showing a front panel surface of the panel assembly of FIG. 12,

FIG. 13 is a rear perspective view of the building structure of FIG. 12 with the panel assembly detached from the frame structure,

FIG. 13A is an exploded view showing part of the frame structure and some of the building blocks forming the panel assembly of FIG. 12,

FIG. 14 is an exploded view showing some components of the frame structure,

FIG. 15 shows a top perspective view of a pen holder,

FIG. 15A shows a top perspective view of the bottom layer of the pen holder assembly of FIG. 15,

FIG. 15B shows a partly exploded view of the bottom layer of FIG. 15A,

FIG. 15C shows a partly exploded view of the top two layers of the pen holder assembly of FIG. 15,

FIGS. 16A and 16B are respectively top perspective views of the building blocks composing the pen holder assembly of FIG. 15 from one side and the other side,

FIG. 16C shows a top perspective view of a second variation of the building block composing the pen holder assembly of FIG. 15,

FIGS. 16D and 16E are respectively top perspective views of a third variation of the building blocks composing the pen holder assembly of FIG. 15 from one side and the other side.

### DESCRIPTION OF EXEMPLARY EMBODIMENTS

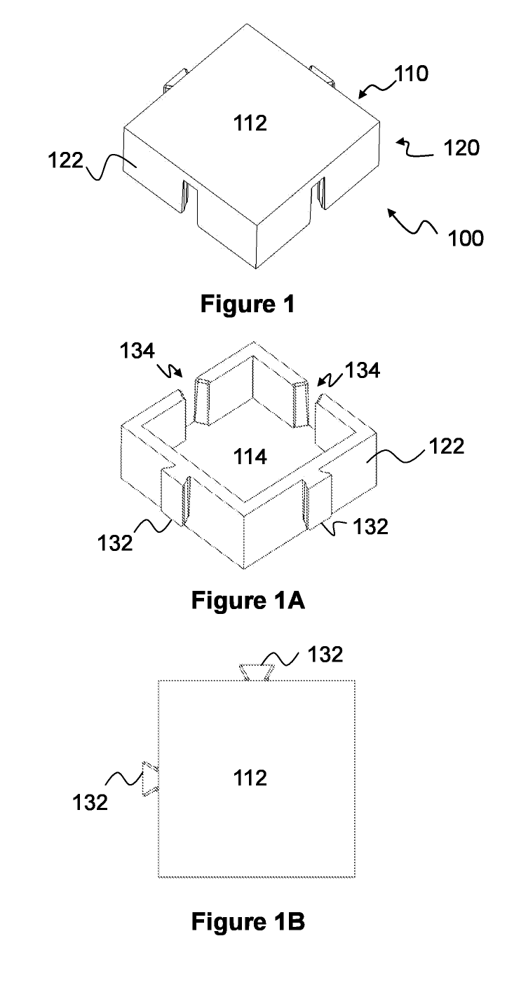

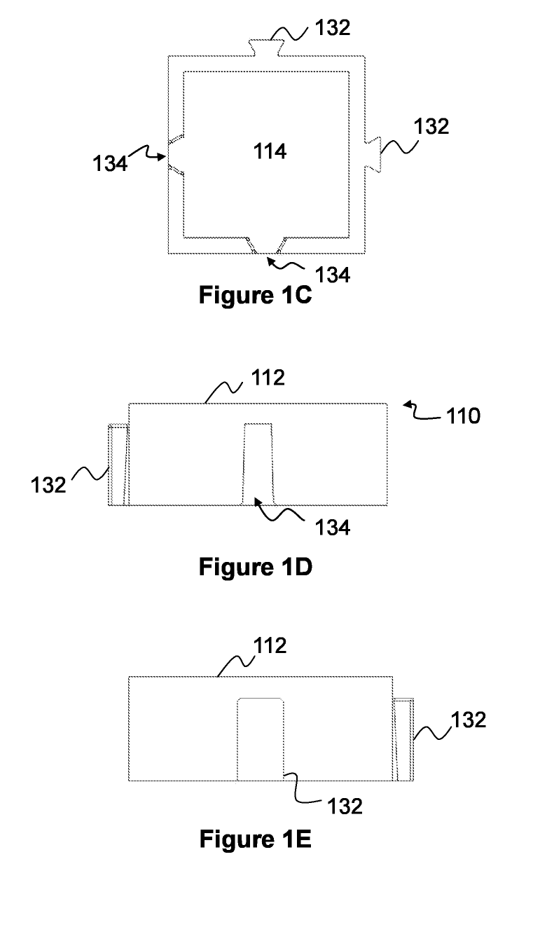

The building block 100 of FIGS. 1 to 1E comprises a panel member 110 and a peripheral skirt 120. The panel member comprises an upper or forward panel surface 112 and a lower or rearward panel surface 114 which is underneath the upper panel surface 112. The upper and lower panel surfaces collectively define the thickness of the panel member 110. The peripheral skirt 120 is downwardly dependent from the panel member 110 and comprises a peripheral wall 122 which surrounds the lower panel surface 114. The peripheral wall 122 follows the outline of the panel member 110 and has a substantially uniform depth extending downwardly from the panel member such that when the peripheral wall 122 of the building block lies on a level supporting surface, the upper panel surface 112 is parallel or substantially parallel to the supporting surface. In general, one end of the peripheral wall 122 joins or intersects with the upper panel surface 112 of the panel member 110 while the other end of the peripheral wall 122 which is a free end distal from the panel member defines the boundary of a second surface. The thickness of the peripheral wall is also substantially uniform along its depth.

The peripheral wall defines a compartment having an outline shape which substantially follows that of the panel member, and the second surface is an entry surface into the compartment. For an exemplary building block having a square panel member such as that of the first example, the peripheral skirt defines a square or substantially square compartment. In the exemplary building block, the thickness of the panel member and that of the peripheral wall are about the same. The compartment typically defines a receptacle for making mated interconnection with mating protrusions distributed on a building block underneath to form a vertically stacked assembly of building blocks. Building blocks in a vertical stack may be further interlocked to enhance structural robustness. In general, the receptacle is defined collectively by the panel member, the second surface and the peripheral wall. The example building block is integrally moulded of hard plastics to promote structural integrity, reliability and cost reduction.

A plurality of interconnection means is distributedly formed on the peripheral skirt 120. In the exemplary building block of FIG. 1 having a square panel member, an interconnection means is formed on each of the four sides of the peripheral skirt. The interconnection means is adapted for making sideway interconnection with a complementary interconnection means on an adjacent building block, and is designed such that when the building blocks are interconnected, the upper panel surfaces of the adjacently interconnected building blocks are flush. The plurality of interconnection means comprises at least a male type interconnection member 132 and at least a female type interconnection member 134.

The male type interconnection member 132 comprises a wedge-shaped portion or a dovetail portion as an example of a wedging means which projects outwardly from the peripheral wall. The wedge-shaped portion comprises a boss or head portion which is distal from the peripheral skirt, and a narrowed neck portion which is intermediate the boss or head portion and the peripheral skirt. The neck portion comprises a stem member which projects orthogonally from the peripheral wall until joining a head or boss portion at an end distal from the peripheral wall. This stem portion also extends in a direction parallel to the upper panel surface. The boss or head portion tapers towards the peripheral skirt to form the wedging portion and the tapering stops before reaching the peripheral skirt so that a length of neck portion of a substantially uniform thickness is maintained immediately adjacent the peripheral skirt to provide adequate neck strength. The projected wedge-shaped portion is recessed from the upper panel surface and extends downwardly from a level below the upper panel surface towards the bottom of the peripheral skirt. The bottom of the wedge-shaped portion is flush with the bottom of the peripheral wall. The wedge-shaped portion has a substantially constant or uniform cross-section extending downwardly from the lower panel surface. As such, the wedge-shaped portion of the building block of FIG. 1 is substantially a wedge shaped block. The axis of the wedge shaped block is parallel or substantially parallel to the peripheral wall, or is orthogonal or substantially orthogonal to the upper panel surface.

The female type interconnection member 134 comprises a recess which extends from a level below the upper panel surface until the bottom of the peripheral skirt, thereby defining a through elongate recess extending from the free end of the peripheral wall which is distal from the forward panel surface to the forward panel surface. The recess is complementarily shaped to the male interconnection member to facilitate mated interconnection. More specifically, the recess is a wedge shaped recess extending on the peripheral skirt in a direction orthogonally to the upper panel surface. The recess is elongate and has a substantially uniform cross section along its length. In other words, the axis of the recess is orthogonal or substantially orthogonal to the upper panel surface.

By having a pair of complementary interconnection members disposed at a level below the upper panel surface, or more specifically below the lower panel surface, sideway interconnection of building blocks can be facilitated without exposing the interconnection members on the upper panel surface. Such an arrangement mitigates the risk of inadvertent or deliberate removal of a building block from the outside of a structure, as the interconnection means is not directly viewable or accessible from outside. In addition, the interconnection means is disposed on a middle portion of the peripheral wall so that adjacent building blocks can be connected with edges easily aligned without complicated alignment requirements.

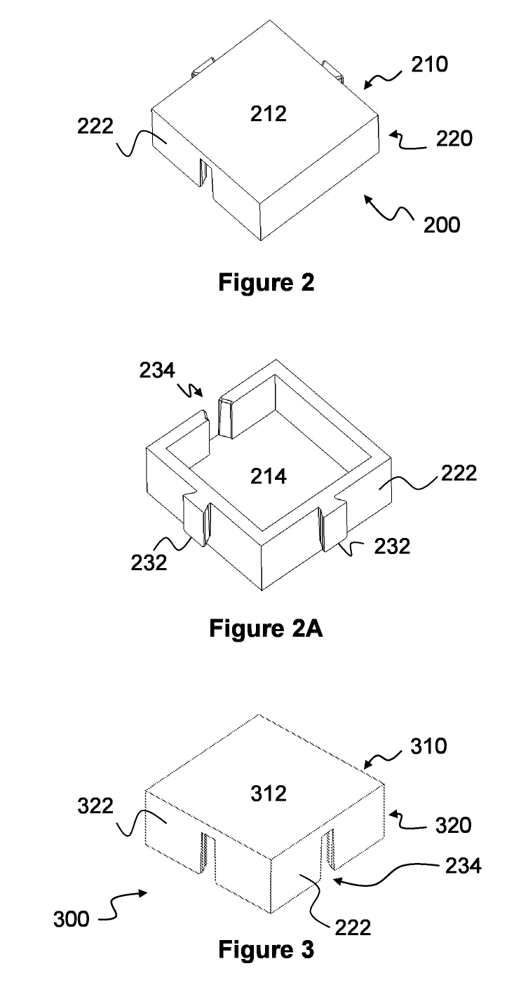

The second example building block 200 as shown in FIGS. 2 and 2A is identical to that of the first example building block, except that interconnection means are formed on three sides only such that one of the side walls is completely smooth and continuous. The above description on the first example building block 100 is incorporated herein for the description of the second example building block where appropriate to avoid duplication, except that the numerals are added by 100 without loss of generality.

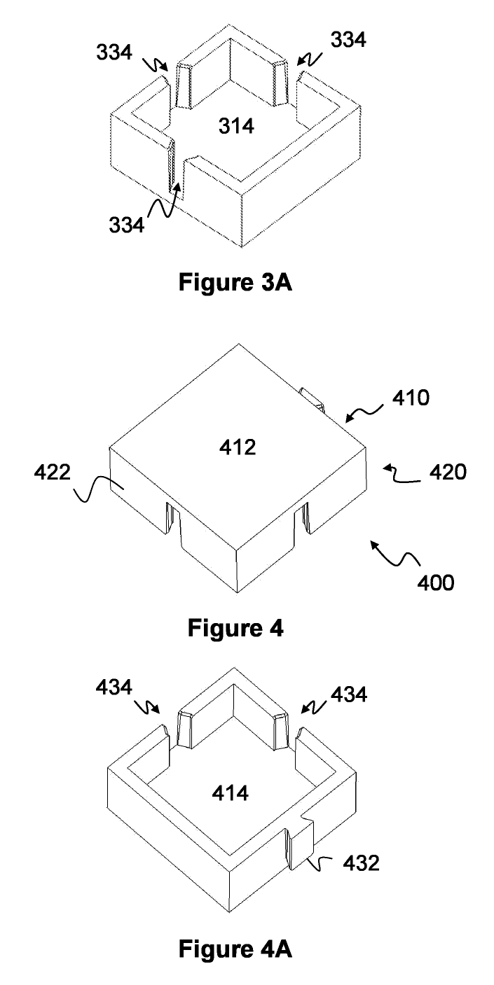

The third example building block 300 as shown in FIGS. 3 and 3A is identical to that of the second example building block, except that all the interconnection means are of the female type. The above incorporated description on the second example building block 200 is incorporated herein for the description of the third example building block where appropriate to avoid duplication, except that the numerals are added by 100 without loss of generality.

The fourth example building block 400 as shown in FIGS. 4 and 4A is identical to that of the second example building block, except that there are one male type and two female type interconnection means, compared to one female type and two female type interconnection means in the second example. The above incorporated description on the second example building block 200 is incorporated herein for the description of the fourth example building block where appropriate to avoid duplication, except that the numerals are added by 200 without loss of generality.

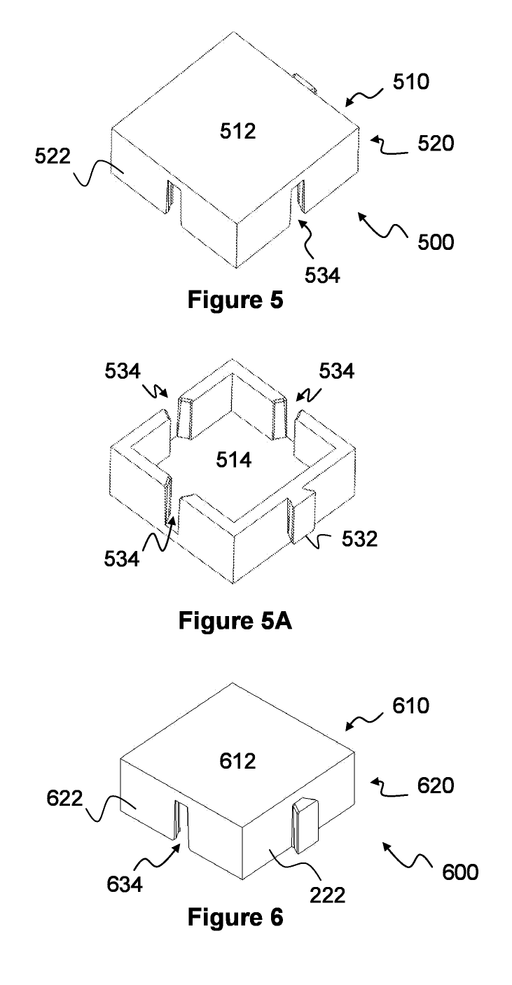

The fifth example building block 500 as shown in FIGS. 5 and 5A is identical to that of the first example building block, except that interconnection means comprises one male type and three female type interconnection members. The above description on the first example building block 100 is incorporated herein for the description of the fifth example building block where appropriate to avoid duplication, except that the numerals are added by 400 without loss of generality.

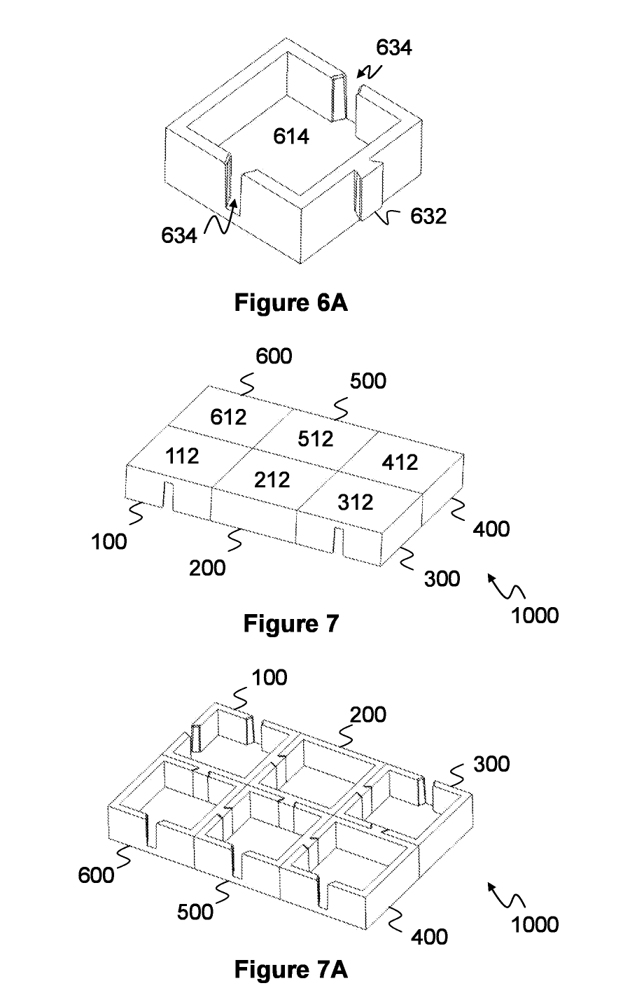

The sixth example building block 600 as shown in FIGS. 6 and 6A is identical to that of the fourth example building block, except that the one male type is intermediate the two female type interconnection means when compared to fourth example. The above incorporated description on the fourth example building block 400 is incorporated herein for the description of the sixth example building block where appropriate to avoid duplication, except that the numerals are added by 200 without loss of generality.

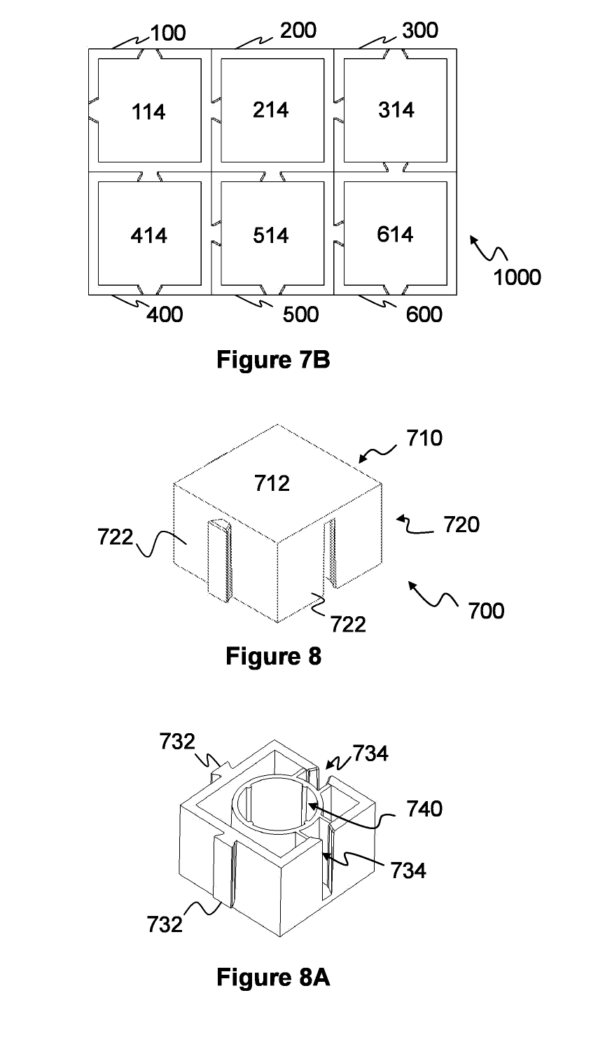

An example panel assembly 1000 shown in FIGS. 7, 7A and 7B comprises six building blocks in sidewise locked interconnection to collectively form a panel assembly. The panel assembly is assembled from one each of the first to the sixth example building blocks and comprises an assembled panel surface which is collectively formed by the upper panel surfaces 112, 212, 312, 412, 512, 612 of the first to the sixth building blocks. As shown in FIG. 6, only the upper panel surface boundaries of the six building blocks are accessible from the front or top surface of the panel assembly and the interconnection means are not accessible from the front or top surface of the panel.

An example construction of the panel assembly 1000 is by placing all the building blocks on a supporting surface such that the second surfaces are facing upwards and the upper panel surfaces are facing the support surface. The first building block 100 having two male interconnection members on adjacent sides is then mounted onto the second 200 and sixth 600 example building blocks by inserting the male interconnection members of the first building block into the corresponding female interconnection members on the second and the sixth building block until the male interconnection member is stopped by the panel member in which case the upper panel surfaces 112, 212, 612 will be flush with each other. For example, the male connection member 132 of the first building block 100 is inserted into the female connection member of the second example building block 200 by making entry into the elongate recess 234 at the second surface of the second example building block and then advance along the elongate recess towards the panel member in a forward axial direction. Likewise, the male connection member 132 of the first building block 100 is inserted into the female connection member of the second example building block 600 by making entry into the elongate recess 634 at the second surface of the second example building block and then advance along the elongate recess towards the panel member in a forward axial direction. It will be noted that further advancement in the axial forward direction beyond the panel member will be blocked by the panel member. As the limit of forward axial movement is determined by the panel member, a building block can only be removed from the panel assembly in a backward axial direction, that is, in a direction moving from the panel member towards the second surface. As shown in FIG. 7, only the boundary lines of upper panel surface are accessible from the front side of the panel member.

The other building blocks are assembled in the same or similar manner until all the building blocks are interconnected. It will be appreciated that the engagement, dis-engagement, interconnection or removal of building blocks has to be performed from behind the panel surfaces as the interconnection means are not accessible from the front panel surfaces. This mitigates the risk of vandalism as the location or presence of the interconnection means is not readily viewable from the front side. In addition, the interconnection means which are received behind the front panel surface also facilitate a neat junction pattern in a panel comprising the assembly of building blocks.

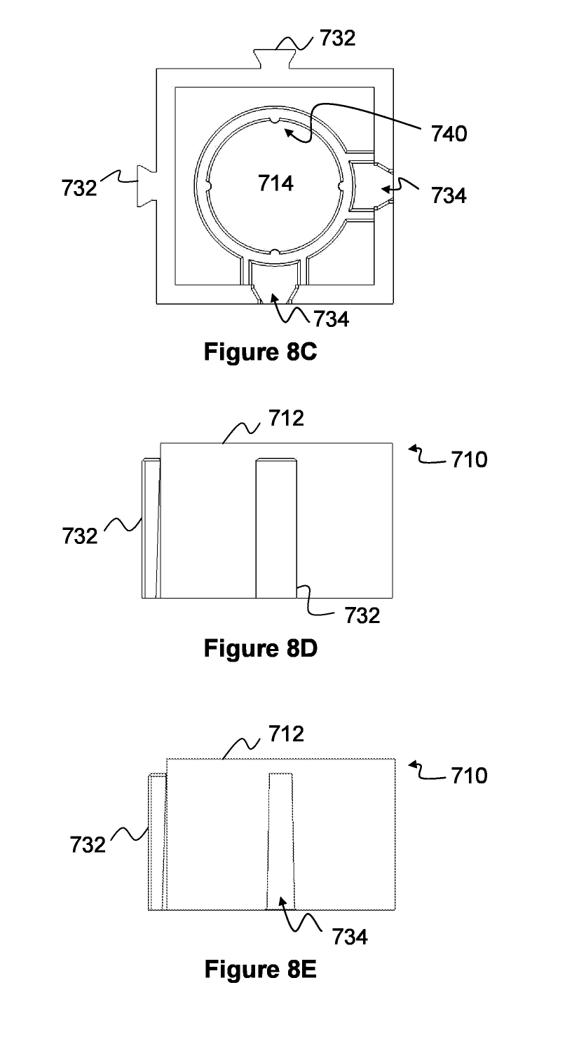

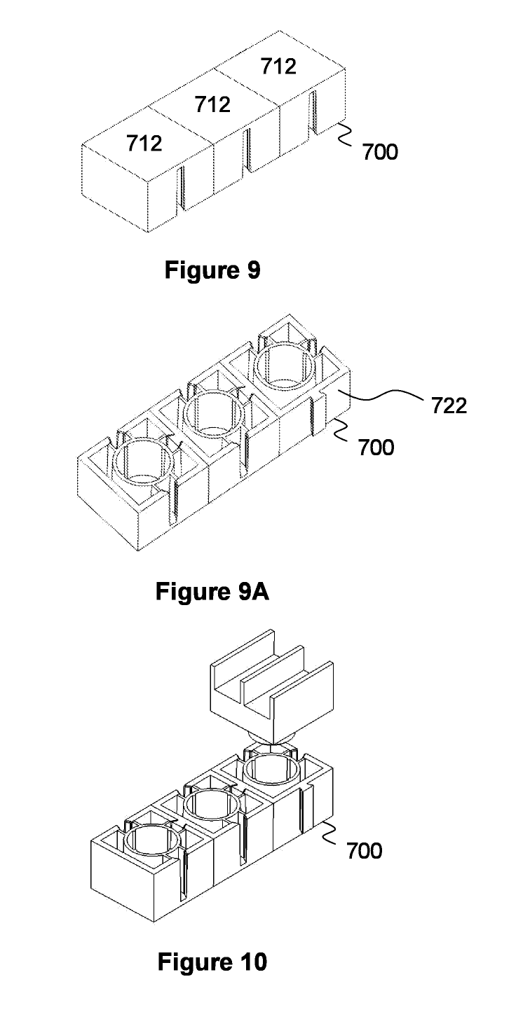

FIGS. 8 to 10 are other example building blocks which are substantially identical or equivalent to that of the first to the sixth examples, except that mechanical coupling means 740 for making mating interconnection with mating protrusions distributed on a building block or building blocks underneath are provided in the compartment or receptacle defined by the peripheral skirt.

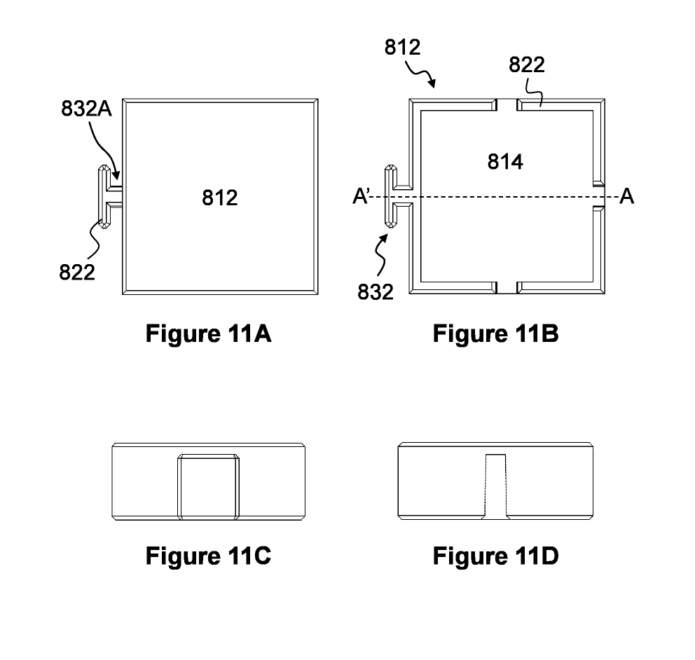

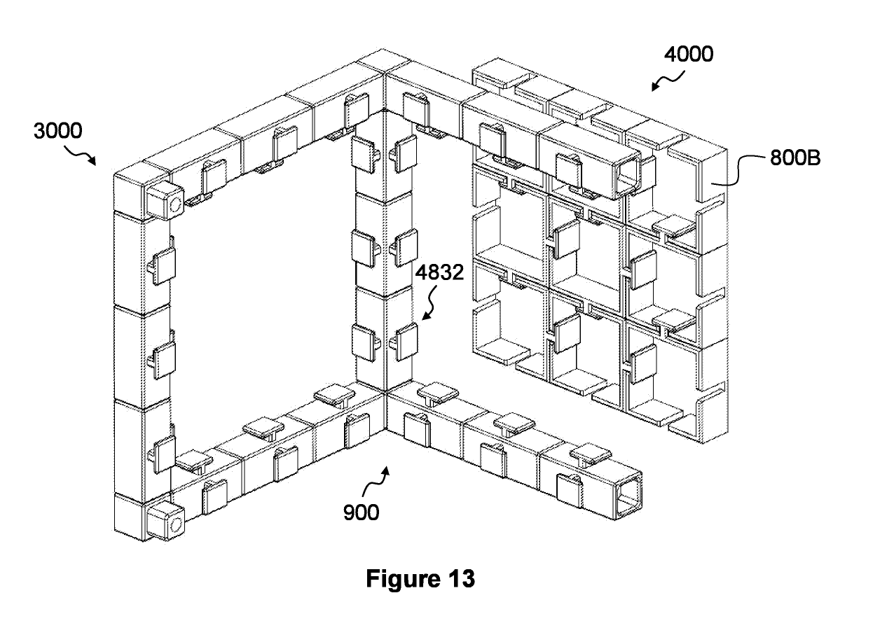

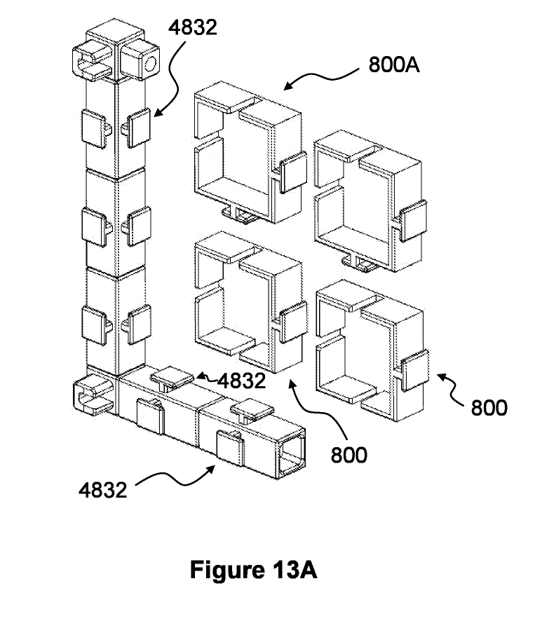

The eighth example building block 800 shown in FIG. 11 is substantially identical or similar to the other example building blocks of FIGS. 1 to 6 and 8 except that the male connection member 832 of the interconnection means is a T-shaped member which is formed on a peripheral wall 822 and projects orthogonally therefrom with a transversely extending head distal from the peripheral wall 822. The building block 800 comprises a panel member 810 having an upper or forward panel surface 812, a lower or rearward panel surface 814 which is on opposite side of the upper panel surface, and a plurality of peripheral walls 822 which collectively form a peripheral skirt 820. The peripheral wall (or the peripheral skirt) extends in an axial direction from the forward panel surface which is defined by the upper panel surface 812 of the panel member towards a second surface the boundary of which is defined by the end of the peripheral skirt which is a free end distal from the forward panel surface. Each connection member of the interconnection means extends from the second surface towards the forward panel surface but stops before reaching the forward panel surface. The T-shaped male connection member has a substantially uniform cross section in the direction of the depth of the peripheral wall and comprises an elongate neck portion 832A which projects orthogonally from the peripheral wall 812 until joining with an elongate end member 832B which extends transversely to the elongate neck portion. The elongate end member 832B is spaced apart from the peripheral wall and extends in a direction parallel to the panel member. This elongate end member is adapted to be received inside the compartment or receptacle of a counterpart building block to facilitate locked interconnection of sidewise adjacent building blocks as shown in FIG. 13. As the second surface of a building block defines an entry into the receptacle to that building block, the second surface is usually mounted or supported on a backing building block.

As this eighth example building block is substantially identical to the other example building blocks, descriptions on the other example building blocks is incorporated herein where appropriate to avoid duplication, except that the numerals are added by 100 or appropriate multiples of 100 without loss of generality.

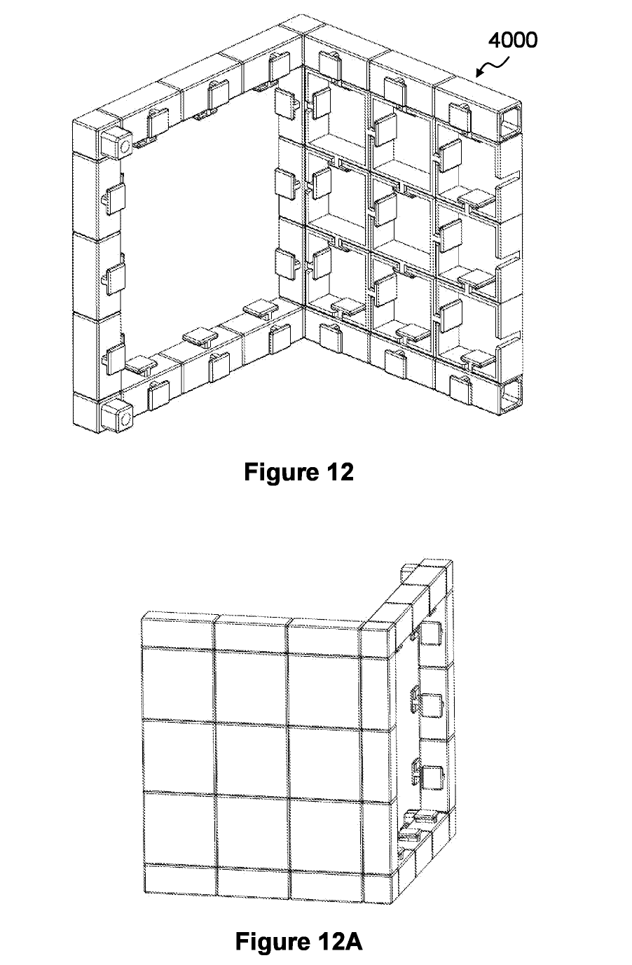

An example building structure 4000 shown in FIG. 12 comprises a panel assembly 2000 that is detachably mounted on a structure frame 3000. The panel assembly as shown in FIGS. 12, 12A and 13 comprises the eighth example building blocks 800 and variant building blocks 800A, 800B. The variant building blocks 800A and 800B are substantially identical to the eighth example building block 800 except that male connection members 832 of the first variant building block 800A are formed on adjacent peripheral walls, and the second variant building block 800B comprises only or all female connection members. To assembly the panel assembly, an eighth example building block, including its variants, having an interconnection means is coupled with an adjacent building block having a complementary interconnection means to facilitate mated or locked sidewise interconnection between adjacent building blocks. Similar to the other building block examples, a building block having a male connection member is moved in an axial forward direction upon encountering a complementary connection member in order to facilitate locked coupling with an adjacent building block. Alternatively, a building block having a female connection member can be moved in a backward axial forward direction upon encountering a counterpart connection member in order to facilitate locked coupling with an adjacent building block. In either ways, the upper panel surfaces of the adjacent building blocks will be flush on locked interconnection.

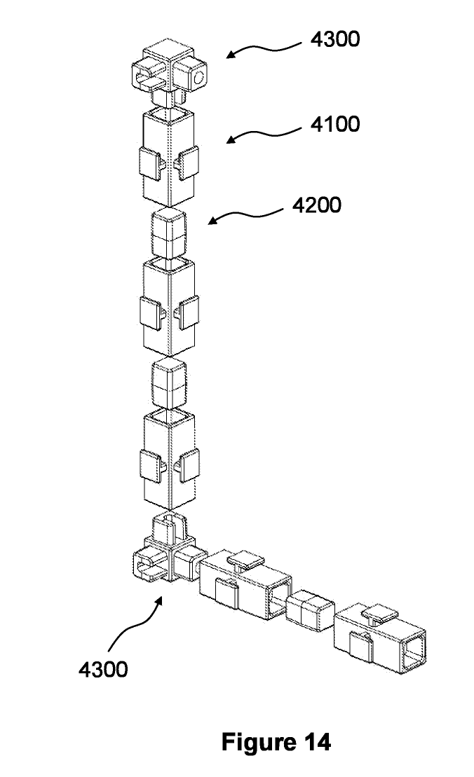

The panel assembly 4000 is then mounted onto a structure frame 3000 by moving in a backward axial direction towards the structure frame 3000 upon encountering the male connection members distributed on the structure frame 3000. As shown in FIGS. 13, 13A and 14, the frame structure 3000 is constructed from a serial connection of building blocks 4100 and building block connectors 4200, 4300. The building block 4100 comprises a tubular block having first and second tubular ends interconnected by a rectangular shaped peripheral skirt. Male connection members 4832 identical to the male connection member 832 are distributed on adjacent surfaces on the peripheral skirt. The structure frame defines a window frame with the male connection members 4832 projecting orthogonally inwardly towards the inside of the window space. The panel assembly 4000 is mounted on the structure frame by sliding into locked interconnection in the backward axial direction. It will be appreciated from FIG. 12A that the collective upper panel surface is flat or leveled across the entire front panel surface and only connection lines defining the panel member of individual building blocks are forward facing.

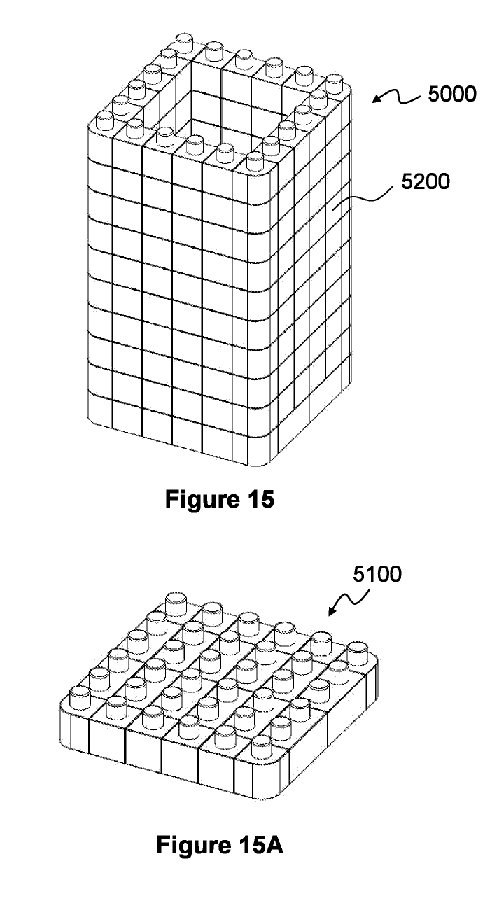

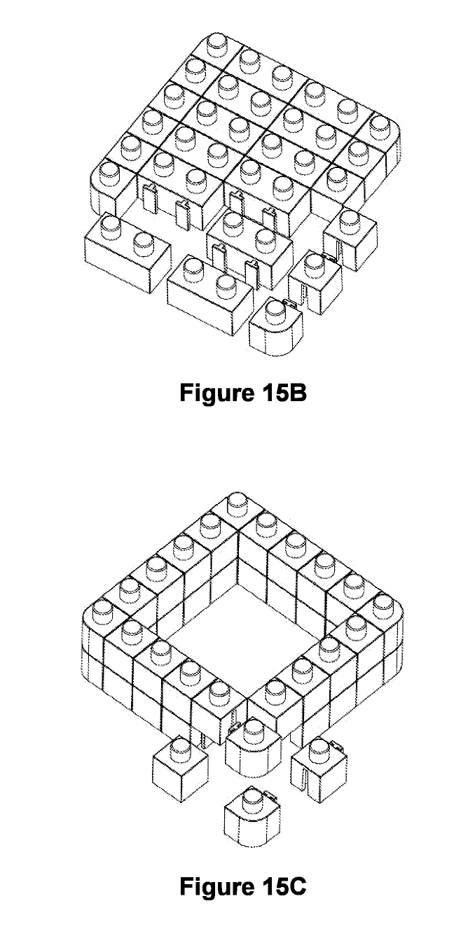

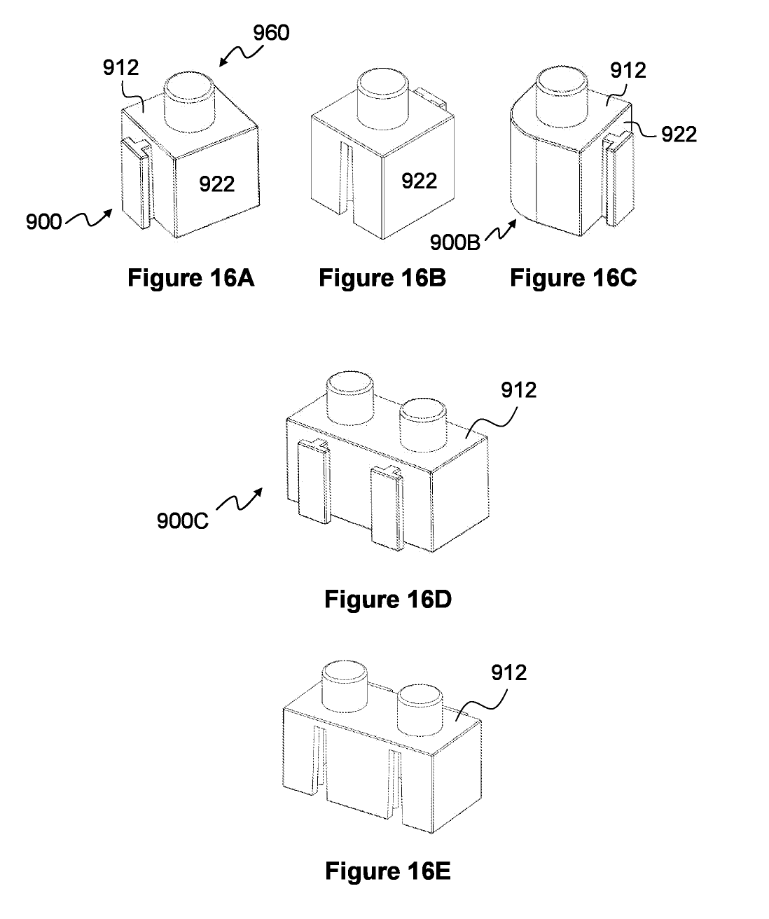

FIG. 15 is a perspective view of a pen holder illustrating an example of a building structure which is assembled from building blocks comprising a plurality of the ninth example building block 900 as shown in FIGS. 16A and 16B and its variations 900B and 900C as shown in FIGS. 16C to 16E. The pen holder 5000 comprises a closed pen holder base 5100 and a peripheral wall 5200 extending vertically upwards from the base. The peripheral wall and the closed pend holder base collective defines a vertically extending pen holder compartment having a pen entry aperture at the top end of the peripheral wall. The ninth example building block 900 is substantially identical to the eighth example building block except that there is an additional mating protrusion 960 which projects orthogonally from the upper panel surface of the building block in a forward axial direction. The mating protrusion is adapted for making mated engagement with a counterpart mating receptacle on the underside of a building block immediately above to facilitate vertical coupled interconnection between adjacent building blocks. The counterpart mating receptacle can be same as that of the seventh example building block of FIG. 8C or can be variants or modifications that are complementary to the mating protrusion. The mating protrusion has a cylindrical outer peripheral to facilitate coupling with no or minimal directional restrictions in a plane orthogonal to the axis of the cylindrical mating protrusion.

The receptacle on the underside of the panel member 910 may be a plain receptacle such as that of FIG. 1 or a mating receptacle of the seventh example building block. Similar to the eight example building block, the interconnection members on the peripheral skirt 912 may be male connection members only, female connection members only, or a combination of both the male and female connection members.

In a second variation 900B of the ninth example building block as shown in FIG. 16C, the peripheral skirt has a rounded side intermediate two flat peripheral walls 922. A male member projects orthogonally from the flat peripheral wall. A male or female interconnection member may be formed on the other flat peripheral wall without loss of generality. This variation of the ninth example building block having a rounded peripheral wall is used to form a rounded edge of the pen holder. Similar to other example building blocks, the longitudinal ends of the interconnection means are retracted from the upper panel surface 912.

The third variation 900C of the ninth example building block as shown in FIGS. 16D and 16E is substantially identical to that of the building block 900 and its variations except that a the panel member has a rectangular upper and lower panel surfaces and a plurality of linearly distributed mated protrusions projects orthogonally from the forward panel surface. In addition, a plurality of interconnection means is distributed on a side peripheral wall to provide distributed interlocking.

While building block examples have been explained with reference to the examples above, it will be appreciated that the embodiments are non-limiting examples only and should not be used for scope limitation or restriction. For example, while each of the exemplary building blocks includes a square panel member, the panel members could have any appropriate shapes such as polygonal, circular, oval or even irregular without loss of generality. Moreover, as the peripheral skirt follows the outline of the panel member, it follows that the peripheral skirt would be correspondingly shaped. For example, for application as a toy building block, the thickness of the panel member and/or the peripheral skirt may be in the region of 1.5-2.5 mm. While the above features have been explained with reference to plastic moulded exemplary building blocks, it will be appreciated that the building blocks can be moulded from concrete, metal, or other mouldable materials; or made from non-mouldable materials such as wood or metal components without loss of generality.

1. A building block comprising a panel member having a forward panel surface and a rearward panel surface, and a peripheral skirt extending rearward from the rearward panel surface and defining a receptacle; wherein an interconnection means adapted for making sidewise locked interconnection with an adjacent building block having a complementary or counterpart interconnection means is formed on the peripheral skirt, the interconnection means being a female connection member or a male connection member complementary to the female member; wherein the female member is shaped or adapted to permit a male connection member of the adjacent building block to enter into sidewise locked interconnection by entering at the free end of the peripheral skirt which is distal from the panel member, to move towards the forward panel surface, and to stop before reaching the forward panel surface.

2. A building block according to claim 1, wherein the entirety of the interconnection means is located rearward of the forward panel surface, such that the interconnection means is blocked from forward access by the forward panel surface when the interconnection means is engaged in sidewise locked interconnection with the adjacent building block.

3-16. (canceled)

17. A building block according to claim 2, wherein the boundary of the panel member defining the forward panel surface includes no sidewise indentation and no sidewise protrusion.

18. A building block according to claim 2, wherein the boundary of the panel member defining the forward panel surface defines a circle, an oval or a convex polygon.

19. A building block according to claim 2, wherein the panel member forms a portion of the female connection member which is adapted to stop movement of the male connection member of the adjacent building block to reach the forward panel surface on entering into the sidewise locked interconnection.

20. A building block according to claim 2, wherein the female connection member is adapted such that when the male connection member on the adjacent building block is blocked or stopped by the female connection member on advancing towards the forward panel surface, the forward panel surface of the adjacent building block is flush with the forward panel surface.

21. A building block according to claim 2, wherein an elongate aperture is formed on the peripheral surface to define the female connection member, the elongate aperture being a cut-through on the peripheral skirt which extends from the free end of the peripheral skirt towards the panel member.

22. A building block according to claim 21, wherein the elongate aperture terminates at the rear panel surface or before reaching the forward panel surface.

23. A building block according to claim 2, wherein the female connection member has a wedge shaped profile in the sidewise direction to formed sidewise wedged engagement with the male connection member.

24. A building block according to claim 2, wherein the male connection member projects orthogonally away from the peripheral skirt and comprises an elongate member which extends in a direction orthogonally to the forward panel surface, the elongate member terminates before reaching the forward panel surface.

25. A building block according to claim 24, wherein the male connection member comprises a T-shaped portion projecting from the peripheral skirt, the end of the T-shaped portion most distal from the peripheral skirt is adapted to protrude into the receptacle of that adjacent building block to form the side wise locked interconnection.

26. A building block according to claim 25, wherein the receptacle is adapted for making mated or coupled engagement with a counterpart building block in a direction orthogonal to the forward panel surface.

27. A building block according to claim 25, wherein a plurality of mating protrusions for making mated engagement with a counterpart building block in a direction orthogonal to the forward panel surface is distributed on the forward panel surface.

28. A building block according to claim 25, wherein a plurality of interconnection means are distributed on the peripheral skirt, the plurality of interconnection means comprising male and female connection members.

29. A panel assembly comprising a plurality of building blocks in sidewise locked interconnection, wherein the building block comprises a panel member having a forward panel surface and a rearward panel surface, and a peripheral skirt extending rearward from the rearward panel surface and defining a receptacle; wherein an interconnection means adapted for making sidewise locked interconnection with an adjacent building block having a complementary or counterpart interconnection means is formed on the peripheral skirt, the interconnection means being a female connection member or a male connection member complementary to the female member; wherein the female member is shaped or adapted to permit a male connection member of the adjacent building block to enter into sidewise locked interconnection by entering at the free end of the peripheral skirt which is distal from the panel member, to move towards the forward panel surface, and to stop before reaching the forward panel surface.

30. A panel assembly according to claim 29, wherein the panel assembly comprises a leveled or flat panel surface formed collectively from the forward panel surfaces of a plurality of the building block.

31. A panel assembly according to claim 29, wherein the entirety of the interconnection means is located rearward of the forward panel surface, such that the interconnection means is blocked from forward access by the forward panel surface when the interconnection means is engaged in sidewise locked interconnection with the adjacent building block.

32. A panel assembly according to claim 29, wherein the boundary of the panel member defining the forward panel surface includes no sidewise indentation and no sidewise protrusion.
